(19) United States
(12) Patent Application Publication
(10) Pub. No.: US 2016/0180459 A1
(43) Pub. Date: Jun. 23, 2016

(54) SLICER ORDER MANAGEMENT TOOL

(71) Applicant: TRADING TECHNOLOGIES INTERNATIONAL INC., Chicago, IL (US)

(72) Inventors: Andrew Theodore RENALDS, Chicago, IL (US); Tom HALDES, Chicago, IL (US)

(21) Appl. No.: 14/576,183

(22) Filed: Dec. 18, 2014

(51) Int. Cl. G06Q 40/04

(52) U.S. Cl. CPC G06Q 40/04

(57) ABSTRACT

The patent document relates to slicer order management. An example method includes receiving a definition for a slicer order including a time variance and a slicer order type, calculating an order schedule including a start time and a plurality of entry times based on the received time variance and the slicer order type wherein each of the plurality of entry times corresponds to one of a plurality of child orders, calculating an entry range for each of the plurality of entry times specified as part of the order schedule wherein the entry range is calculated based on the time variance, calculating an adjusted entry time within each of the calculated entry ranges, calculating an updated order schedule based on the calculated adjusted entry times, and communicating at least one of the plurality of child orders to a market offered at an electronic exchange according to the updated order schedule.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

A slicer order is a synthetic strategy that involves breaking or slicing the total quantity associated with one parent order into smaller quantities associated with multiple component orders that are traded separately. A slicer order may be, for example, a time sliced order, a volume sliced order or any combination of the two. In practice, slicer orders may be utilized to reduce the market impact when, for example, the total quantity specified in connection with the parent order is large relative to market liquidity.

### BRIEF DESCRIPTION OF THE DRAWINGS

Certain embodiments are disclosed with reference to the following drawings.

FIG. 1 illustrates a block diagram representative of an example exemplary electronic trading system in which a slicer order management tool may be employed.

FIG. 2 illustrates a block diagram of an exemplary electronic trading system in which a slicer order management tool may be employed.

FIG. 3 illustrates a block diagram of an exemplary computing device, which may be used to implement the disclosed embodiments.

FIG. 4 illustrates a block diagram of an exemplary apparatus for obfuscating the schedule of child orders.

FIG. 5A illustrates a representation of an order schedule based on a time variance of zero.

FIG. 5B illustrates another representation of an order schedule based on a non-zero time variance.

FIG. 5C illustrates another representation of another order schedule based on a non-zero time variance.

FIG. 6A illustrates an exemplary graphical user interface (GUI) associated with the order schedule shown in FIG. 5A;

FIG. 6B illustrates an exemplary graphical user interface (GUI) associated with the order schedule shown in FIG. 5B;

FIG. 6C illustrates an exemplary graphical user interface (GUI) associated with the order schedule shown in FIG. 5C;

FIG. 7 illustrates a flow diagram of exemplary processes executed to perform the obfuscated scheduling functionality.

The disclosed and discussed embodiments, features and advantages will be better understood when read in conjunction with the provided drawings, which illustrate examples. It should be understood, however, that the embodiments are not limited to the arrangements and instrumentality shown in the attached drawings.

### DETAILED DESCRIPTION

The present disclosure generally relates to order management tools, and more particularly to a slicer order management tool configured to manage the placement of slicer child orders at an electronic exchange.

In certain embodiments, an example slicer order management tool is configured to alter the placement sequence including the position and timing interval between subsequent child orders detailed in an order schedule. In certain embodiments, the example slicer order management tool is configured to generate an order schedule based on a time variance and a slicer order type. In certain embodiments, the example slicer order management tool is configured to augment and/or update an existing order schedule based on a time variance.

In certain embodiments, an order schedule managed by a slicer order management tool configured according to the disclosure provided herein includes varied or obfuscated sequence of entry times corresponding to the placement of slicer child orders at an electronic exchange. The sequence of entry times may be obfuscated utilizing a time variance as a basis for an entry range. An updated entry time can, in turn, be established within each entry range. In certain embodiments the updated entry time can be any randomly selected time with the entry range. In another embodiment, the updated entry time can be determined based on placement rules. An example placement rule may consider the distance between entry times within the obfuscated sequence. In another example, a placement rule could direct that a first entry time corresponding to the end of a first entry range corresponds to a start time of a second entry range to define a continuous sequence.

### I. BRIEF DESCRIPTION OF CERTAIN EMBODIMENTS

In certain embodiments, a method of slicer order management is disclosed. The example method includes receiving a definition for a slicer order including a time variance and a slicer order type, calculating an order schedule including a start time and a plurality of entry times based on the received time variance and the slicer order type wherein each of the plurality of entry times corresponds to one of a plurality of child orders, calculating an entry range for each of the plurality of entry times specified as part of the order schedule wherein the entry range is calculated based on the time variance, calculating an adjusted entry time within each of the calculated entry ranges, calculating an updated order schedule based on the calculated adjusted entry times, and communicating at least one of the plurality of child orders to a market offered at an electronic exchange according to the updated order schedule.

### II. EXAMPLE ELECTRONIC TRADING SYSTEM

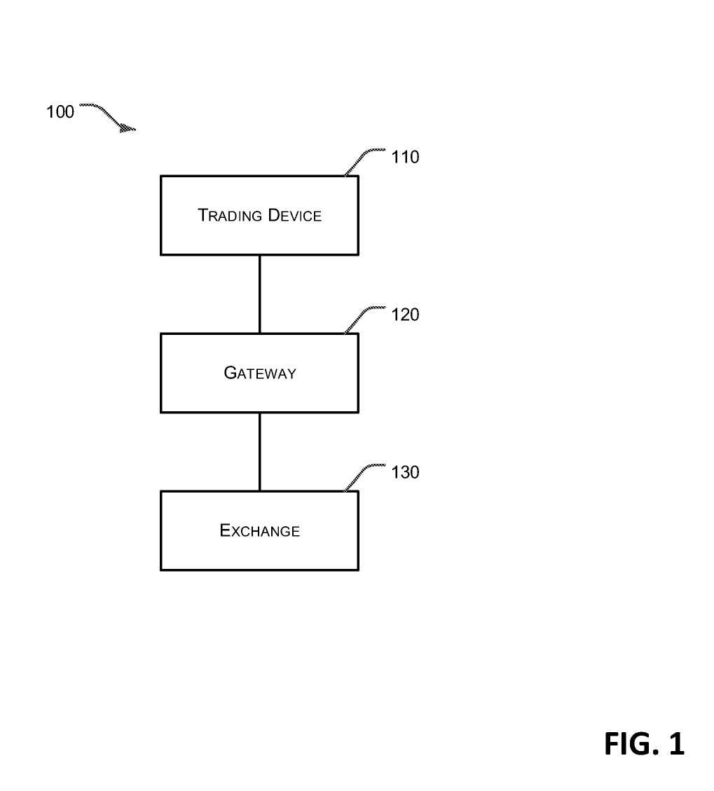

FIG. 1 illustrates a block diagram representative of an example electronic trading system 100 in which a slicer order schedule variation tool may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data related to a market for a tradeable object. For example, market data may include the inside market, market depth, last traded price (“LTP”), a last traded quantity (“LTQ”), and/or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything that may be traded. For example, a quantity of the tradeable object is bought or sold at a price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (also referred to a real tradeable object), a product defined by the user (also referred to as a synthetic tradeable object), and/or a combination of real or synthetic products. There may be a synthetic tradeable object that corresponds and/or is similar to a real tradeable object.

An order message is a message that relates to a trade order. A trade order may be, for example, a command to place an order to buy or sell a tradeable object; a command to initiate managing orders according to a defined trading strategy; a command to change, modify, or cancel an order; an instruction to an electronic exchange relating to an order; and/or combinations thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass features where an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order.

In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor child orders while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. After an order to buy or sell a tradeable object is received and confirmed by the exchange, the order may be considered to be a working order until it is filled or cancelled. If only a portion of the quantity of the order is matched, then the partially unfilled quantity remains working. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 may be adapted to publish market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

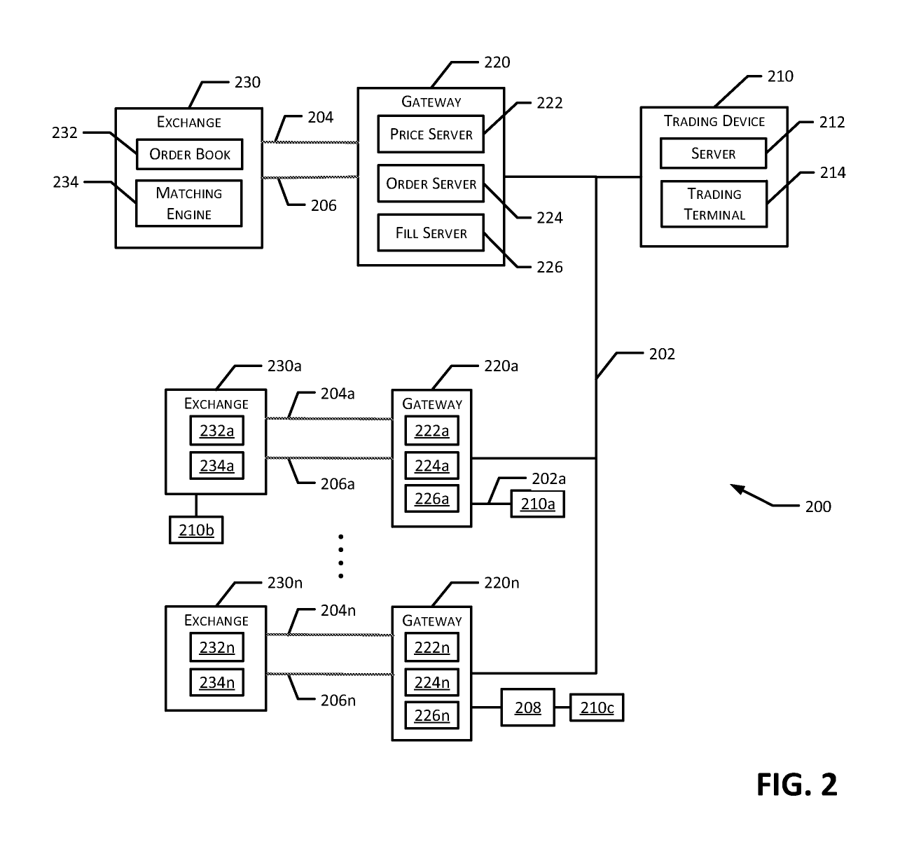

FIG. 2 illustrates a block diagram of another exemplary electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically proximate to the gateway 220. For example, the server 212 may be physically closer to the gateway than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. EXAMPLE COMPUTING DEVICE

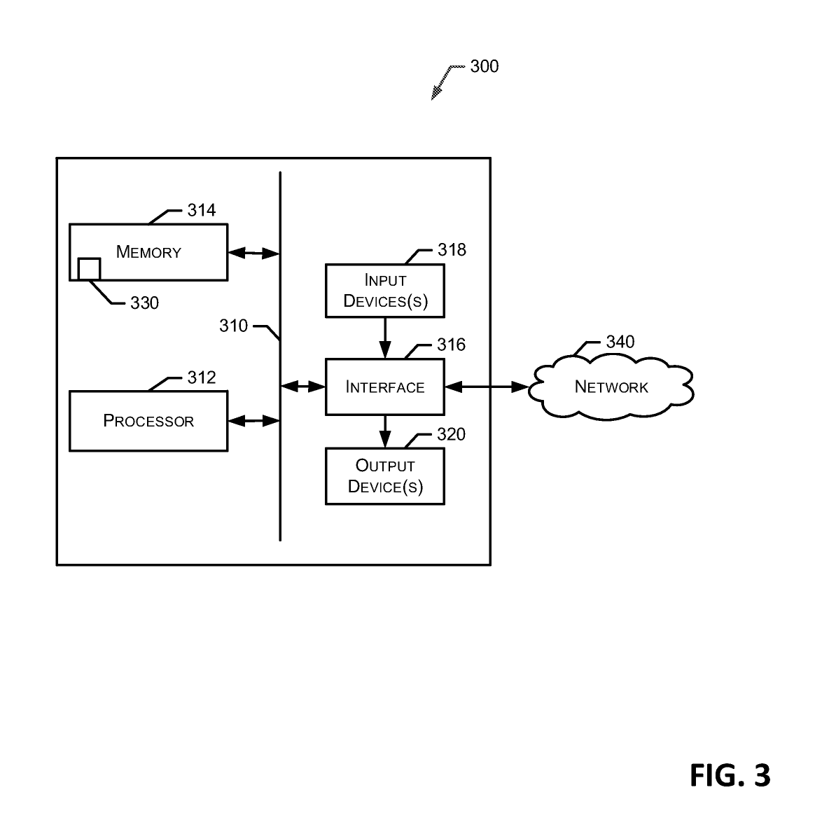

FIG. 3 illustrates a block diagram of an example computing device 300 which may be used to implement the disclosed embodiments. The trading device 110 of FIG. 1 may include one or more computing devices 300. The gateway 120 of FIG. 1 may include one or more computing devices 300. The exchange 130 of FIG. 1 may include one or more computing devices 300.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. SLICER ORDER MANAGEMENT TOOL

An example slicer order management tool is disclosed and described herein. The example slicer order management tool augments and/or modifies an order schedule utilized to direct the placement activities of a slicer order by altering the placement sequence or sequence (e.g., the timing and/or position) of component order entry times. In certain embodiments, the example slicer order management tool may replace current tools, engines and/or methodologies for scheduling and controlling the placement of the individual component orders at an electronic exchange.

A slicer order involves breaking or separating a total quantity associated with the slicer order into multiple component orders. The components orders can, in turn, be traded separately on an electronic exchange. There are multiple types of slicer orders (i.e., slicer order types) such as, for example, an iceberg order, a volume sliced order, a time sliced orders, a time-duration sliced order, and a volume-duration sliced order. An iceberg order is a slicer order type that submits a new component order in response to the complete fill of the previous component order. A volume sliced orders is a slicer order type that submits a new component order once a predetermined volume of trades has occurred on the electronic exchange. A time sliced order is a slicer order type that specifies placement of component orders at fixed time intervals. A time duration sliced order is a slicer order type that specifies a total time by which all of the component orders are to be placed. A volume-duration sliced order is a slicer order type that specifies a total volume of contracts traded in the market by the time all of the component orders are to be placed.

An order to be sliced into multiple component orders, regardless of order type, is referred to herein as a parent order. Each parent order indicates a price and includes a parent quantity. The slices or components of a parent orders are referred to herein as child orders. Additional parameters and characteristics such as, for example, a disclosed percentage, disclosed volume, and a leftover action may be included in the definition of the slicer order. The price may be a single discreet price, a synthetic price, and/or a range of prices or price modifiers. The parent quantity is the total quantity to be broken down into child quantities. In practice, the sum total of all associated child order quantities equals the total quantity of the parent order. The individual child order may be submitted to a market according to a slicer order schedule.

Slicer order schedules defined for time and/or duration-based slicers specify the quantity and time at which each child order is to be sent to the market. An example slicer order schedule for a time-sliced order specifies the time interval at which individual child orders are to be sent to a market. In certain embodiments, the expiration of a time interval or entry time acts as a trigger resulting in a trading device sending a child order to the market. The order schedule specifies quantities and the number of child orders to be sent to market as well as the individual times at which each child order is to be sent. In operation, an exemplary order schedule for a time sliced order might specify that ten (10) child orders, each for a quantity of one hundred and twenty-five (125) contracts, are to be sent every forty-five (45) seconds. The order schedule may further specify the entry times as individual time entries in a sequence. For example, the sequence for the ten (10) child orders may be zero (0), forty-five (45), ninety (90), one-hundred thirty-five (135), one-hundred eighty (180), two-hundred twenty-five (225), two-hundred seventy (270), three-hundred fifteen (315), three-hundred sixty (360), and four-hundred five (405) seconds.

For additional information regarding slicer orders, the disclosure of U.S. Pat. Nos. 8,041,622, 8,732,067, and co-pending U.S. patent application Ser. No. 13/737,715, commonly assigned to Trading Technologies, are each incorporated by reference in their entirety for all purposes.

The example slicer order management tool disclosed and described herein is configured to generate an order schedule based on a time variance and a slicer order type. In certain embodiments, the example slicer order management tool is configured to augment and/or update an existing order schedule based on a time variance.

The present disclosure relates to a slicer order management tool. The slicer order management tool provides a mechanism to obfuscate the placement of child orders in order to avoid detection of the total quantity being traded. Current slicer orders and/or order slicing techniques utilize slicer order schedules that specify the communication of child orders to the market(s) at uniform and predictable intervals.

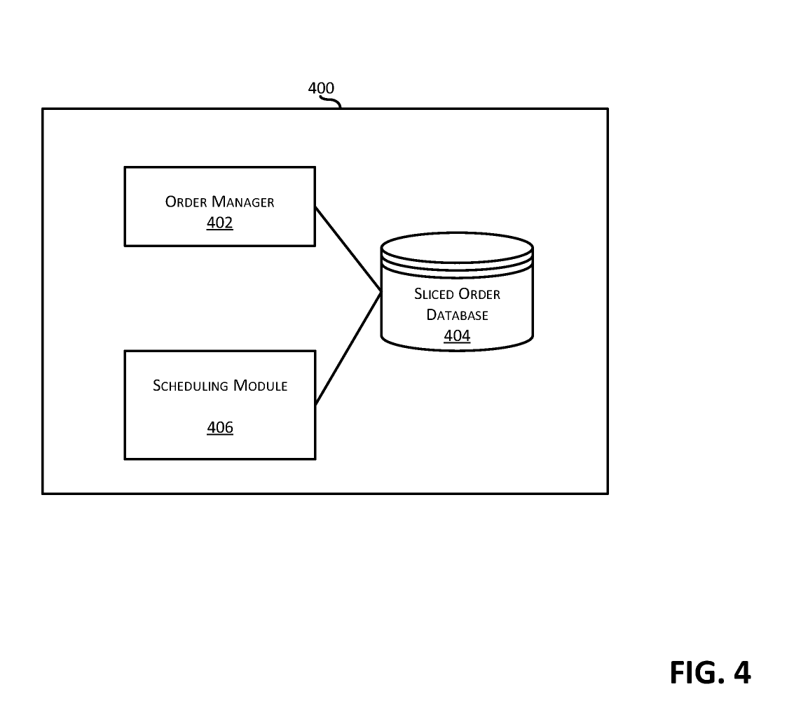

FIG. 4 is a block diagram of an exemplary slicer order management tool 400. The slicer order management tool 400 may be implemented exclusively in hardware, exclusively in software, exclusively in firmware, or in any combination of hardware, software, and/or firmware. The slicer order management tool 400 includes an order manager 402 in communication with a sliced order database 404 and a scheduling module 406.

The disclosed slicer order management tool 400 may be utilized in connection with current slicer orders and the associated slicer order schedules to direct placement of child orders in a manner that appears unpredictable to an outside observer. The disclosed slicer order management tool utilizes a time variance to control the placement of a child order with respect to an entry range established as part of the current slicer order schedule.

The order manager 402 breaks down a parent order into one or more child orders based on the parameters and information included in a received slicer order definition. For example, the order manager 402 may break down a parent order in accordance with preset parameters, such as parameters provided by a user. The parameters may be locked parameters such as those required or specified by a slicer order type, and/or other slicer order parameters specific to the execution or implementation of the slicer. For example, the order manager 402 may be configured with user instructions; user defined and/or locked parameters and other values regarding the quantities, intervals, triggers, prices, duration, variance, etc. necessary to implement the breakdown of a parent order. The order manager 402 may be configured to accessibly store the slicer order definition containing, for example, the user instructions, the present parameters, and/or one or more user-defined locked parameters to the order database 404.

The sliced order database 404 may be configured to store and organize the slicer order definition as well as any associated or resulting data such that the information may be retrieved and utilized in operation by the slicer order management tool 400. In certain embodiments, the order database 404 may be a separate database configured to communicate with the slicer order management tool 400. The order database 404 may communicate a stored slicer order definition and/or one or more individual parameters to the scheduling module 406 for processing.

The scheduling module 406 receives slicer order definition and parameters from the sliced order database 404. The scheduling module 406, in turn, cooperates with the order manager 402 and the slicer order definition and parameters to generate an order schedule according to the disclosure provided herein. The generated order schedule directs the submission of individual child orders at a market offered by an electronic exchange. The generated order schedule is based on the slicer order data received from the order database 404.

In operation, the slicer order management tool 400 directs the order manager 402 to cooperate with the scheduling module 406 to generate a varied slicer order schedule that governs the submission of individual child orders into the market. In particular, the slicer order management tool 400 may utilize user-provided parameters and information stored in the sliced order database 404 to generate a schedule for slicing and segmenting a parent order. The slicer order management tool 400 provides a mechanism by which the order schedule can be generated and/or configured to obfuscate the placement of child orders. By adjusting the placement timing of the individual child orders, the order schedule generated by the slicer order management tool 400 may conceal placement activity of an active slicer order. In this way, the exemplary slicer order management tool 400 submits child orders to the market in a seemingly random manner that makes detection and/or manipulation of the slicer order difficult.

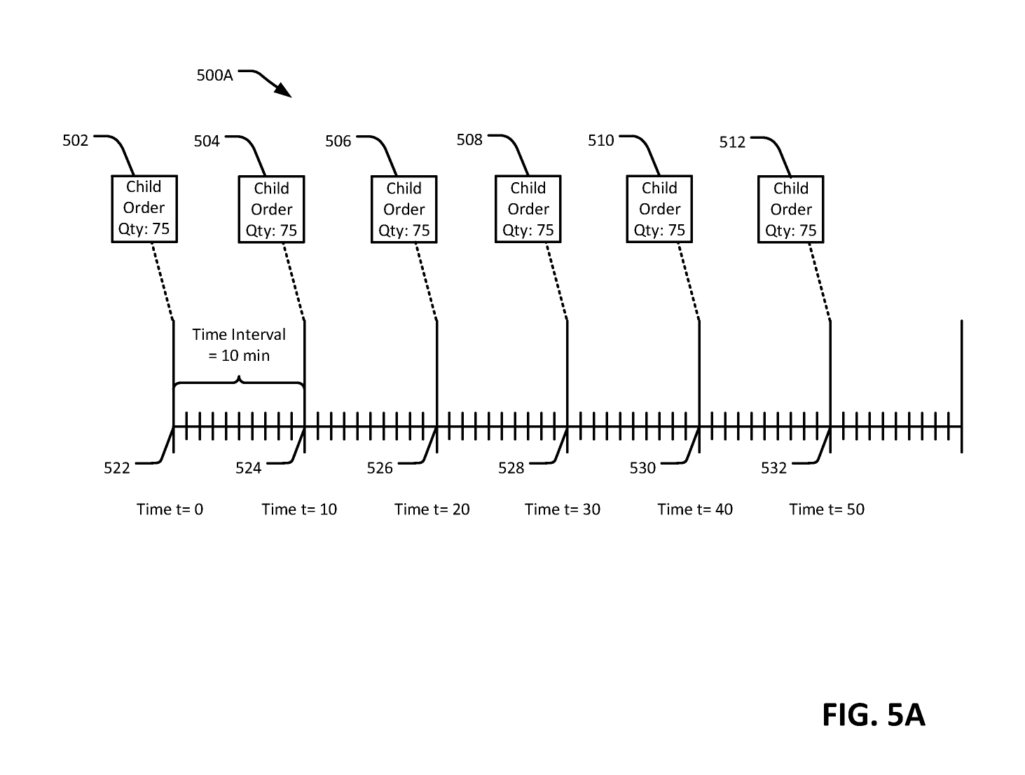

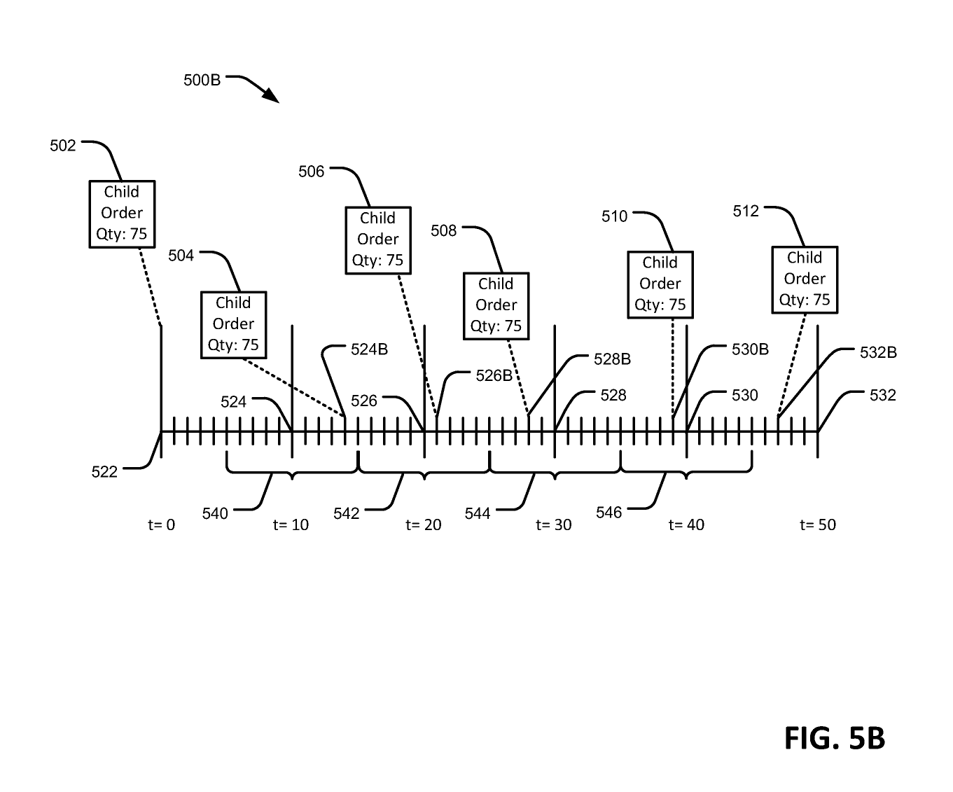

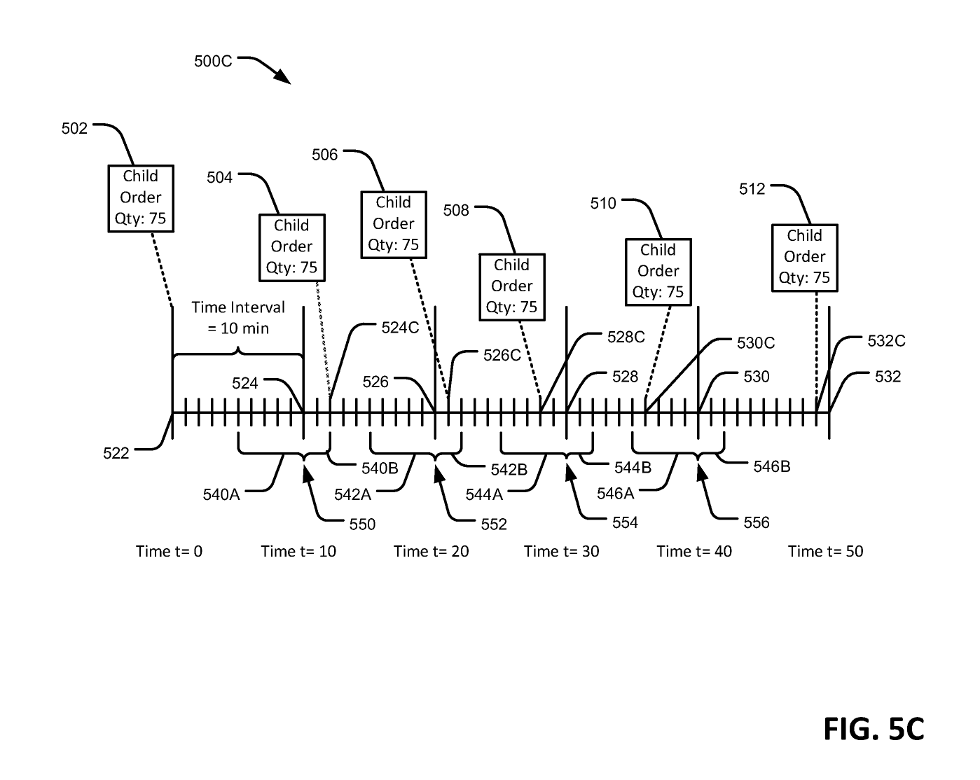

FIG. 5A illustrates an example of an order schedule that may be varied in connection with one or more of the embodiments disclosed herein. In particular, FIG. 5A illustrates an order schedule 500A that may be generated in connection with a time-based slicer order. The example order schedule 500A reflects a time variance of zero (0) resulting in no entry time variance being incorporated into the sequence of entry times specified by the order schedule generated by the order manager 402 and the scheduling module 406. The example order schedule 500A further reflects a volume variance of zero (0).

The example order schedule 500A illustrates a sequence or plan by which a parent order having a total quantity of four-hundred fifty (450) can be sliced or separated into six (6) child orders. The six (6) individual child orders include individual quantities of seventy-five (75) and are uniquely identified as child orders 502 to 512. The generated order schedule indicates that the six (6) child orders are to be submitted at entry times 522 to 532. The entry times 522-532 are child orders placed at ten (10) minute time intervals beginning with an initial placement at entry time 522.

FIG. 5A further illustrates that the slicer order may be activated at a start time (e.g., time t=0) depicted as time entry 522. Upon activation at entry time 522, the trading device (e.g., the trading device 210) sends the initial child order 502 for a quantity of seventy-five (75) contracts to market at a specified price. The specified price may, for example, be a price determined relative to the inside market, a price calculated or derived based on another tradeable object, and/or a desired price or price range. In the illustrated example of FIG. 5A, the order schedule 500A instructs each of the remaining five (5) child orders 504 to 512 to be sent at regular ten (10) minute intervals relative to the start time (e.g., t=0) identified as the initial time entry 502. In other words, ten (10) minutes after the start of the slicer order indicated by the initial submission of the child order 502 at entry time 522, a second child order 504 is sent by the slicer order management tool 400 at entry time 524. The sequence of child order submissions occurring at ten (10) minute time intervals (i.e., entry times 524-532) continues until all six (6) child orders and the total of four-hundred fifty (450) contracts has been sent to the market.

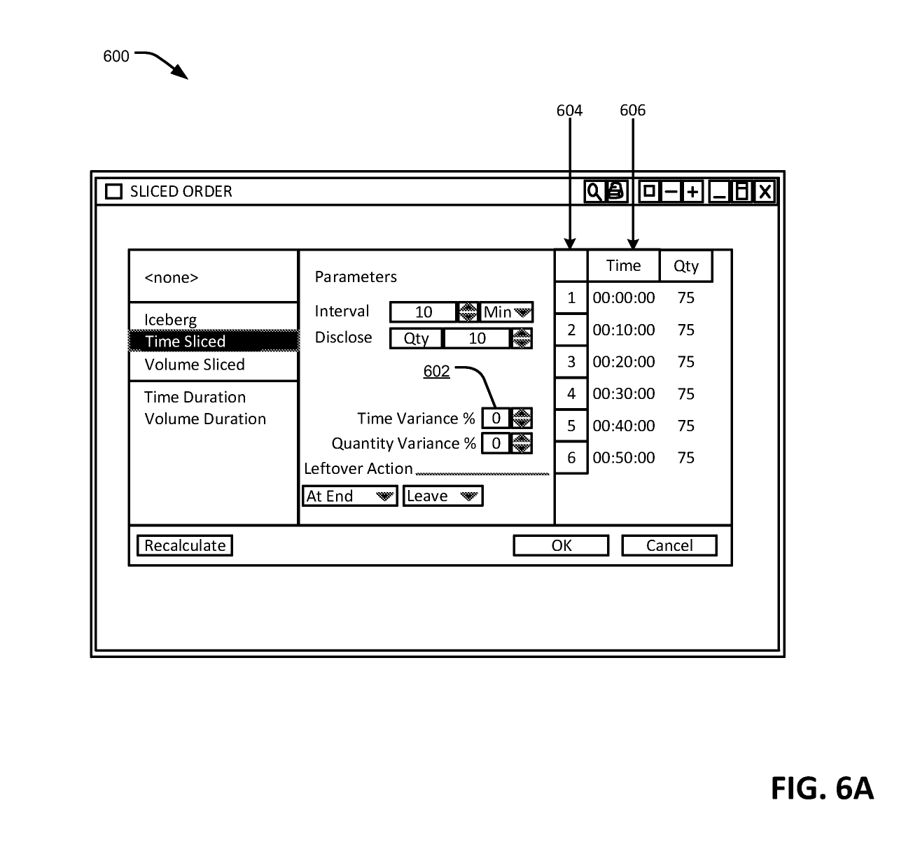

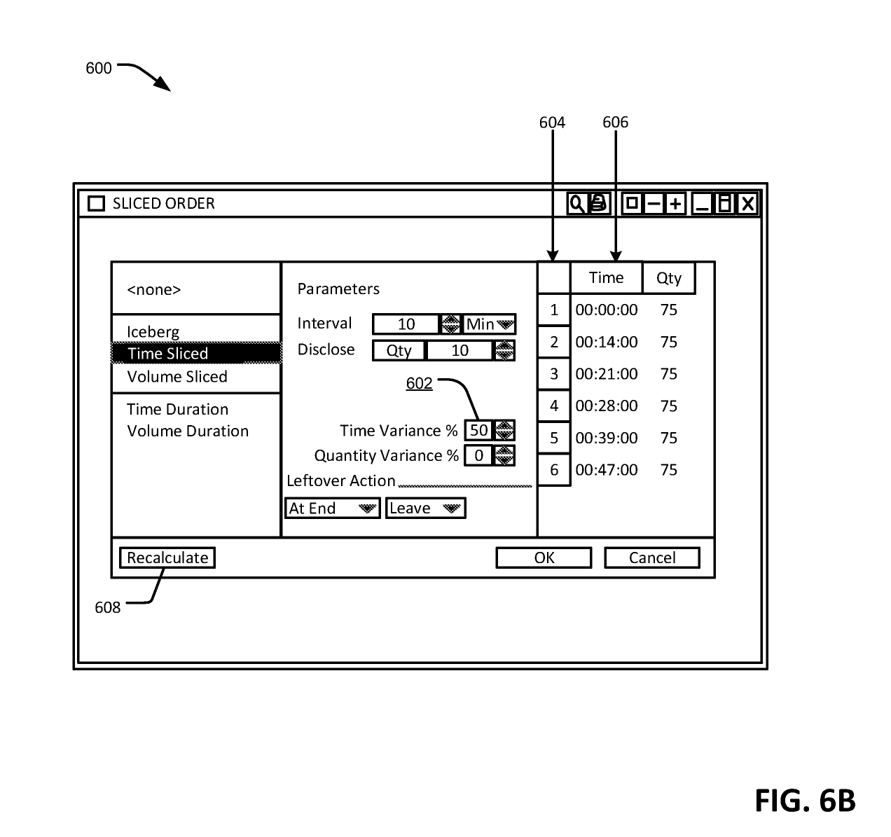

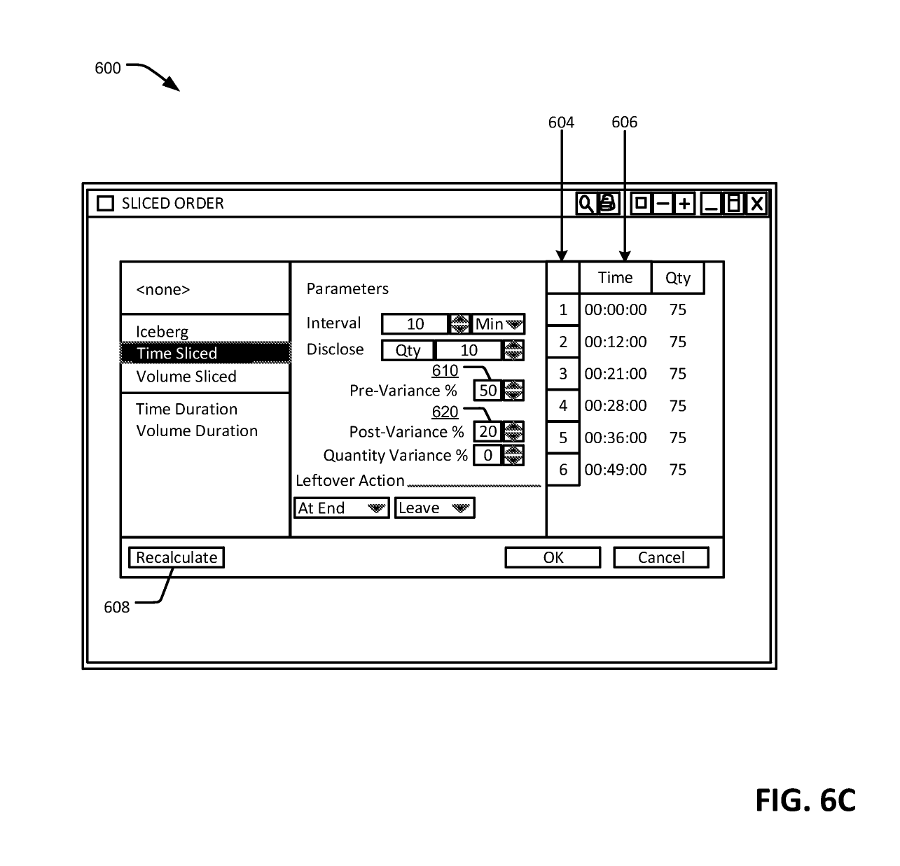

FIG. 6A illustrates a graphical user interface (GUI) 600 implemented by the trading device 210 shown in FIG. 2 and configured to generate or otherwise compile a slicer order definition including calculated and/or compiled slicer order parameters. In particular, the graphical user interface (GUI) 600 is configured to define the slicer order used by the slicer order management tool 400 to calculate the order schedule 500A. As shown, the graphical user interface (GUI) 600 is arranged to communicate a time variance parameter 602, an order sequence 604, and entry time information 606 to, for example, the slicer order management tool 400.

FIG. 6A further illustrates one or more of the individual parameters, displayed in the example graphical user interface (GUI) 600, that make up the slicer order definition used to generate the order schedule 500A. For example, the graphical user interface (GUI) 600 indicates a time variance 602 of zero (0). The time variance represents an allowable entry time deviation in the order schedule 500A calculated as a percentage of the time interval between entry times. In the present example, the graphical user interface (GUI) 600 indicates that the time variance equals zero (0). As shown in FIG. 5A, a time variance of zero (0) results in the submission of each child order 504 to 512 occurring at a corresponding entry time 524 to 532. Stated another way, time variance of zero (0) results in no deviation in the submission of the child orders 504 to 512 from the corresponding entry time 524 to 532.

The order sequence 604 indicates the arrangement in which the child orders (e.g., the child orders 502 to 512 shown in FIG. 5A) are to be submitted to the market. The entry time information 606 indicates the times, relative to start of the slicer order, each of the child orders are to be submitted to market. For example, the child order 506 is number three in the order sequence 604 and the entry time information 606 indicates that submission is scheduled to occur twenty (20) minutes after the initial entry time 522.

FIG. 5B illustrates another example of an order schedule varied in connection with one or more of the embodiments disclosed herein. In particular, FIG. 5B illustrates an example of an order schedule 500B generated based on a non-zero time variance in accordance with the embodiments disclosed herein. The example slicer order schedule 500B specifies a varied or obfuscated order schedule based on the time variance parameter 602 of fifty (50) percent shown in FIG. 6B. Time variance parameters in excess of fifty (50) percent of the maximum time interval may result in overlapping entry ranges. The time variance represents an allowable deviation relative to the individual entry times 524 to 532. In certain embodiments, the time variance may be used to calculate high and low range values of an entry range centered on and relative to the individual entry times 524 to 532. The low and high range value can be calculated based on a relationship between the time interval and the time variance 602. The entry range may be calculated as:

low range value=[time interval×time variance]×−1; and (Equation 1)

high range value=time interval×time variance. (Equation 2)

An entry range calculated according to Equations 1 and 2 is centered on an entry time such that a first half of the range occurs before the entry time and the second half occurs after the entry time. For example, by defining the time variance parameter 602 as a fifty (50) percent value, the slicer order management tool 400 calculates the entry range limits relative to the entry time as:

low range value=[time interval×time variance]×−1; (Equation 3)

low range value=[10 minutes×(0.50)]×−1; (Equation 3a)

low range value=−5 minutes; and (Equation 3b)

high range value=time interval×time variance; (Equation 4)

high range value=10 minutes×(0.50); and (Equation 4a)

high range value=5 minutes. (Equation 4b)

The calculated entry range values or limits can, in turn, be used to define an entry range 540 to 546 with respect to each of the entry times 524 to 532. The example entry range 540 to 546 is a symmetrical range centered on each of the entry times 524 to 532. As shown in FIG. 5B, the entry range 540 is symmetrical and centered on the first entry time 524 in the sequence of entry times 522 to 532. The example fifty (50) percent time variance parameter 602 results in half (i.e. five (5) minutes) of the total ten (10) minute time interval occurring before the entry time 524, and half of the total time interval occurring after the entry time 524.

FIG. 5B further illustrates alternate entry times 524B to 532B determined within the established entry ranges 540 to 546. The individual locations within the entry ranges 540 to 546 for each alternate entry time 524B to 532B may be determined randomly. For example, the alternate entry times 524B to 532B may be determined based on a random number selected by the order manager 402 and/or the scheduling module 406. In another alternative, the slicer order management tool 400 may determine alternate entry times 524B to 532B utilizing a marked-based randomization technique. Market-based randomization techniques may be based on one or more market parameters such as the last traded price (LTP), last traded quantity (LTQ), and/or total volume traded. For example, a fluctuating market parameter may be used to generate a unique, and apparently random, deviation and/or variation for each entry time within the entry ranges 540 to 546. In an embodiment, the market-based randomization technique may define a randomization factor based on the first significant decimal of the last traded quantity (LTQ). For example, if the last traded quantity had a value of sixteen (16), the resulting market-based randomization factor would be six (6). In another embodiment, the market-based randomization factor may be based on a cumulative sum and/or average of the last traded quantity (LTQ) calculated over one second intervals. The apparently random deviation associated with the market parameter may be used to determine offsets between the entry times 522 to 532 and the corresponding alternate entry times 524B to 532B. In this way, the entry time associated with each child order 504 to 512 is apparently randomized to an outside observer within the constraints defined by each entry range 540 to 546.

FIG. 6B illustrates the graphical user interface (GUI) 600 configured to generate or otherwise compile a slicer order definition including a non-zero time variance. In the example, the parameters comprising the slicer order definition for the order schedule 500B are displayed in the example graphical user interface (GUI) 600. For example, the graphical user interface (GUI) 600 indicates a time variance 602 of fifty (50) percent. As shown in FIG. 5B, a time variance of fifty (50) percent results in an entry range defined by low and high range values that are half of the total time interval.

FIG. 6B further illustrates the entry time information 606 configured to display the calculated alternate entry times. In particular, once an entry range 540 to 546 has been defined for each of the entry times 524 to 530, the slicer order management tool 400 may calculate corresponding alternate entry times 524B to 532B. In the illustrated example, the alternate entry times 524B to 530B are bounded and/or constrained by their corresponding entry range. In other words, each alternate entry time is calculated within a corresponding entry range in order to preserve the order sequence 604. In the illustrated example, an entry range does not constrain the alternate entry time 532B. Rather, the alternate entry time 532B is constrained between the end of the entry range associated with the alternate entry time 530B and the end of the order schedule indicated by the original entry time 532. In certain embodiments, an entry range or other constraint may be defined in connection with the submission of the last submission corresponding to the alternate entry time 532B

FIG. 5C illustrates another example of an order schedule varied in connection with one or more of the embodiments disclosed herein. In particular, FIG. 5C illustrates an example of an order schedule 500C generated based on multiple time variance parameters in accordance with the embodiments disclosed herein. The example slicer order schedule 500C specifies a varied or obfuscated order schedule based on a pair of time variance parameters 610 and 620. FIG. 6C illustrates the graphical user interface (GUI) 600 displaying the first time variance (e.g., a pre-variance) and the second time variance (e.g., a post-variance). The first and second time variances represent the allowable deviation before and after the individual entry times 524 to 532. In certain embodiments, the two time variances may, in turn, be used to calculate independent high and low range values of an asymmetrical entry range centered on and relative to the individual entry times 524 to 532. The independent high and low range values can be calculated based on a relationship between the time interval and the first time variance 610 and the second time variance 620. The entry range may be calculated as:

low range value=[time interval×first time variance]×−1; and (Equation 5)

high range value=time interval×second time variance. (Equation 6)

The calculated entry range values or limits can, in turn, be used to define an asymmetrical entry range 550 to 556 with respect to each of the entry times 524 to 530. The example entry range 550 to 556 is an asymmetrical range centered on each of the entry times 524 to 530. Each entry range 550 to 556 includes a first portion calculated based on the low range value and an entry and a second portion calculated based on the entry time and the high range value. As shown in FIG. 5C, the entry range 550 is an asymmetrical entry range defined relative to the first entry time 524 in the sequence of entry times 522 to 532. The entry range 550 includes a first portion 540A and a second portion 540B. The example fifty (50) percent first time variance parameter 610 and twenty (20) percent second time variance parameter 620 results in half (i.e. five (5) minutes) of the total ten (10) minute time interval occurring before the entry time 524, and two (2) minutes of the total time interval occurring after the entry time 524. Each of the asymmetrical entry ranges 550 to 556 includes pairs of first and second portions (e.g., 540A and 540B, 542A and 542B, 544A and 544B, and 546A and 546B) calculated according to, for example, Equations 5 and 6.

FIG. 6C illustrates graphical user interface (GUI) 600 configured to vary the slicer order schedule. According the example shown in FIG. 6C, the first time variance parameter 610 is a pre-variance parameter and the second time variance parameter 620 is a post-variance parameter. The pre-variance parameter is configured for a time variance of fifty (50) percent. The post-variance parameter is configured for a time variance of twenty (20) percent. As shown in FIG. 5C, the defined pre-variance parameter and post-variance parameter result in an entry range determined based on low and high range values calculated in Equations 5 and 6. The resulting entry range is seventy (70) percent of the total time interval (i.e., the calculated asymmetrical entry range has a seven (7) minutes period out of the total ten (10) minute period specified as the time interval).

FIG. 6C further illustrates the entry time information 606 configured to display the calculated alternate entry times. In particular, once the entry range 550 to 556 has been defined for each of the entry times 524 to 530, the slicer order management tool 400 may calculate corresponding alternate entry times 524C to 532C (see FIG. 5C). In the illustrated example, the alternate entry times 524C to 532C are bounded and/or constrained by their corresponding entry range. In other words, each alternate entry time is calculated within a corresponding entry range in order to preserve the order sequence 604.

In an embodiment, a change to either the first time variance parameter 610 and/or the second time variance parameter 620 may affect a change to the slicer order schedule in response to a user input, such as operation of the recalculate button 608. The slicer order management tool 400 may update graphical user interface (GUI) 600 with a new slicer order schedule for the slicer order. Additionally or alternatively, the graphical user interface (GUI) 600 may be updated to provide a display to allow a user to accept or reject the varied slicer order schedule.

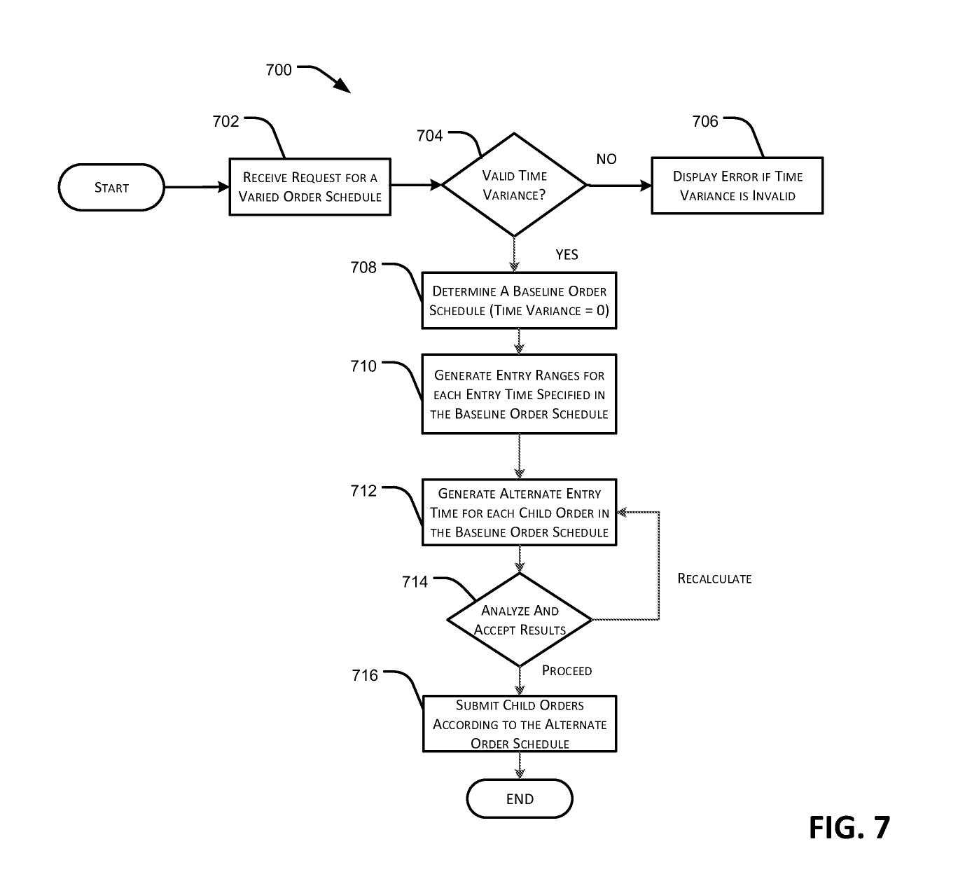

The execution of the user-requested change may be conducted according to a control routine such as control routine 700 shown in FIG. 7. The results generated by the control routine may be utilized by the order manager 402 and the scheduling module 406 to vary the slicer order schedule and update the graphical user interface (GUI) 600. By allowing users to vary the slicer order schedule, the user can avoid detection of his slicer order by eliminating the uniformity of the standard slicer order schedule.

FIG. 7 illustrates an exemplary control routine 700 that may be implemented to vary the schedule of a slicer order. At block 702, control routine 700 may receive a request, such as via a user input, to create a new and/or recalculate an existing slicer order schedule based on the definition provided via the graphical user interface (GUI) 600. In response to receiving the request, the implementation of the control routine 700 may activate and/or access the slicer order management tool 400. For example, a user may define and/or update the time variance 602 interfacing with the graphical user interface (GUI) 600 of FIG. 6B. In response, the slicer order management tool 400 may initiate a calculation of the slicer order schedule. The calculation of the slicer order schedule may generate a new slicer order schedule. In another embodiment, the calculation of the slicer order schedule may update an existing slicer order schedule, such as the slicer order schedule 500A (shown in FIG. 5A), in order to create an updated slicer order schedule such as the slicer order schedule 500B (shown in FIG. 5B).

At block 704, the control routine 700 determines whether or not the time variance 602 is a valid parameter. For example, the control routine 700 may analyze the time variance 602 to determine if it falls within a range of valid values. For example, a default valid range for the time variance could be between a minimum time variance of zero (0%) and a maximum time variance of fifty (50) percent. Alternatively, a valid interval range may be between a minimum time variance of ten (10) percent and a maximum time variance of forty (40) percent. If the control routine 700 determines that the time variance is not within the valid range, then at block 706 an error may be displayed on, for example, the graphical user interface (GUI) 600. Additionally, the control routine 700 (described below) could reset the time variance parameter to a default value, play an audible alert, lock the graphical user interface or any number of methods of indicating the time variance parameter is not valid. However, if the control routine 700 determines at block 704 that the time variance parameter is within the valid range, the control routine 700 proceeds to block 708.

At block 708, the control routine 700 determines or calculates a baseline or reference order schedule as it would be generated without a time variance parameter (i.e. the time variance equals zero). One example of a baseline order schedule may be the order schedule 500A shown in FIG. 5A. Alternatively, the baseline order schedule may be provided as part of the request received at block 702. The baseline order schedule may include a plurality of entry times organized into a sequence. The sequence specifies the order in which each child order is to be submitted to a market placement and the time interval over which the placement is to occur. The baseline order schedule may be a new order schedule generated in response to the request received at block 702 or may be an existing order schedule identified as part of the request. A new order schedule may be based on a definition provided via the graphical user interface 600.

At block 710, the control routine 700 generates an entry range for each entry time specified in the baseline order sequence. For example, as shown in FIG. 5B, the entry range 540 is defined by a high range value and a low range value and is centered on, for example, the entry time 524. As illustrated in FIGS. 5B and 5C, entry ranges are generated for each child order in the placement sequence except for the initial and final child orders. Communication of the initial child order (e.g., child order 502 at entry time 522) to a market corresponds to the start of a slicer order. Once a slicer order is active, the individual child orders are sent to the market according to the order schedule. The final child order is sent to market between the end of the last entry range and the last entry time listed in the sequence. For example, as shown in FIG. 5B, the final child order 512 is sent to market after the entry range 546 and before the entry time 532 specified in the baseline order schedule.

At block 712, the control routine 700 may employ a market-based randomization scheduler and/or scheduling technique to schedule each child order within its respective entry range generated at block 712. For example the order schedule 500B shown in FIG. 5B includes alternate entry times 524B to 530B.

At block 714, the control routine 700 displays the varied order schedule of block 712 with an acceptance prompt on a graphical user interface (GUI) 600. If the control routine 700 determines that the varied order schedule is not accepted, then the control routine returns to block 712 to recalculate the varied order schedule. If, at block 714, the control routine 700 determines that the varied order schedule is accepted, control passes to block 716.

At block 716, the control routine 700 may, in response to the submission of an initial child order (e.g., child order 502), submit orders to the market according to the alternate order schedule. Alternatively, the control routine 700 may communicate the order schedule to a trading device, server or other component shown in, for example, FIG. 2 for submission to the market.

The blocks illustrated by exemplary control routine 700 in FIG. 7 may be completed in a different order of execution, or may be changed, eliminated, sub-divided, or combined. For example, the interval ranges can be calculated without the use of entry times. The entry ranges may be calculated by the slicer order management tool 400 based on the number of child orders (“n”), interval, and time variance. For example if an order schedule may include five (5) child orders, a time interval of ten (10) minutes between child orders, and a time variance parameter of fifty (50) percent. The slicer order management tool 400 can use these three values to calculate the entry ranges. For example entry ranges may be calculates as:

$$\begin{matrix}[ 1 * interval \pm ( interval * time variance ) ] ; & ( Equation 7 ) \\ [ 2 * interval \pm ( interval * time variance ) ] , \\ … & ( Equation 8 ) \\ [ ( n - 1 ) * interval \pm ( interval * time variance ) ] . & ( Equation 9 )\end{matrix}$$

In this way the entry ranges may be calculated without evaluating a baseline order schedule or other schedule generated without a time variance.

In yet another example, the slicer order schedule can be determined in conjunction with the interval ranges. Building on the previous example, the slicer order management tool 400 may employ a random scheduler to schedule each child within its interval range as it is being calculated. In response to calculating all of the interval ranges and scheduling all of the child orders, the slicer order schedule may be presented for acceptance or rejection.

Some of the described figures illustrate example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be substantially minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

What is claimed is:

1. A method comprising:
receiving, by a computing device, a definition for a slicer order including a time variance and a slicer order type;
calculating, by the computing device, an order schedule including a start time and a plurality of entry times based on the received time variance and the slicer order type, wherein each of the plurality of entry times corresponds to one of a plurality of child orders;
calculating, by the computing device, an entry range for each of the plurality of entry times included in the order schedule, wherein the entry range is calculated based on the time variance;
calculating, by the computing device, an adjusted entry time within each of the calculated entry ranges;
calculating, by the computing device, an updated order schedule based on the calculated adjusted entry times; and
communicating, by the computing device, at least one of the plurality of child orders to a market offered at an electronic exchange according to the updated order schedule.

2. The method of claim 1 wherein the definition further includes a parent quantity.

3. The method of claim 2 wherein the parent quantity is divided into a plurality of child quantities each associated with one of the plurality of child orders.

4. The method of claim 1 wherein the order type is selected from the group consisting of: a time sliced order, a volume sliced order, a time duration order, a volume duration order, and an iceberg order.

5. The method of claim 1 further comprising:
communicating, by the computing device, a first child order to the electronic exchange at the start time.

6. The method of claim 1 wherein the order schedule includes an initial entry associated with the start time, wherein the initial entry corresponds to the communication of a first one of the plurality of child orders.

7. The method of claim 1 wherein the entry range includes is centered on one of the plurality of entry times.

8. The method of claim 7 wherein the entry range includes:
a low range value calculated as (entry time×time variance)×−1; and
a high range value calculated as (entry time×time variance).

9. The method of claim 1 wherein the entry range includes an end time and wherein each of the end times corresponds to one of the plurality of entry times.

10. The method of claim 1 wherein the entry range includes is a first range and a second range arranged with respect to one of the plurality of entry times, and wherein the first range is different than the second range.
